(19) United States
(12) Patent Application Publication
(10) Pub. No.: US 2016/0180239 A1
(43) Pub. Date: Jun. 23, 2016

(54) MOTION DETECTION AND RECOGNITION EMPLOYING CONTEXTUAL AWARENESS

(71) Applicant: CloudTalk LLC, Bala Cynwyd, PA (US)

(72) Inventors: Jonathan Frankel, Bala Cynwyd, PA (US); Isaac Levy, New York, NY (US)

(21) Appl. No.: 14/971,179

(22) Filed: Dec. 16, 2015

Related U.S. Application Data
(60) Provisional application No. 62/092,881, filed on Dec. 17, 2014.

(51) Int. Cl. G06N 7/00; G06N 99/00; G06T 7/20

(52) U.S. Cl. CPC G06N 7/005; G06T 7/20; G06N 99/005

(57) ABSTRACT

An artificial intelligence engine may receive a plurality of values from a corresponding plurality of heterogeneous sensors and audio/visual data from a microphone/camera, respectively, corresponding to the detection of motion of an object located in the audio/visual data. The artificial intelligence engine may evaluate context of the plurality of values from the corresponding plurality of heterogeneous sensors and the audio/visual data from the microphone/camera, respectively, in view of one or more past values from the plurality of sensors and one or more past frames of audio/visual data from the microphone/camera, respectively. In response to the evaluated context indicating that the motion of the object is suspicious with a probability equal to or above a level, the artificial intelligence engine triggers an alert indicating that a suspicious event has occurred.

### CROSS-REFERENCE TO RELATED APPLICATIONS

This application claims the benefit of U.S. Provisional Patent Application No. 62/092,881, filed Dec. 17, 2014, the disclosure of which is incorporated herein by reference in its entirety.

### TECHNICAL FIELD

The present invention relates generally to motion detection systems, and more particularly, to a wireless motion detection system comprising a plurality of heterogeneous sensors and a cameras/microphone in signal communication with an application processing unit that employs an artificial intelligence engine to correlate data from the sensors and the camera/microphone to detect intrusion events.

### BACKGROUND

Motion detection systems have been employed to help facilitate the detection of intruders in buildings related to the home, businesses, government facilities, etc. These systems typically employ one or more still or video cameras located in various rooms communicatively connected to a central panel where a guard monitors the cameras to detect suspicious motion. In the home, security systems typically rely on an image or small series of images from a single camera. This reliance on a single camera and a few images can limit the intelligence of the motion detection and recognition software by preventing the software from making accurate predictions using the overall context in which motion is taking place.

### SUMMARY

The above-described problems are addressed and a technical solution is achieved in the art by providing a processing unit that employs an artificial intelligence engine to correlate data from sensors and a camera to detect intrusion events. In an example, the artificial intelligence engine may receive a plurality of values from a corresponding plurality of heterogeneous sensors and audio/visual data from a microphone/camera, respectively, corresponding to the detection of motion of an object located in the audio/visual data. The artificial intelligence engine may evaluate context of the plurality of values from the corresponding plurality of heterogeneous sensors and the audio/visual data from the microphone/camera, respectively, in view of one or more past values from the plurality of sensors and one or more past frames of audio/visual data from the microphone/camera, respectively. Responsive to the evaluated context indicating that the motion of the object is suspicious with a probability equal to or above a level, the artificial intelligence engine may be configured to trigger an alert indicating that a suspicious event has occurred. The plurality of values and/or the plurality of past values may be captured over a period of time. The period of time may correspond to time before, during, and after the occurrence of the suspicious event.

### BRIEF DESCRIPTION OF THE DRAWINGS

FIG. 1 is a block diagram of plan view of a home having a plurality of rooms therein, in which is distributed a microphone, a plurality of sensors and one or more cameras 108 and interconnected by the system described in FIG. 3.

FIG. 2 is a block diagram of plan view of multiple homes, each having a plurality of rooms therein, over which the plurality of sensors and cameras are distributed and interconnected by the main unit described in FIG. 3.

FIG. 3 is a block diagram of elements comprising a main unit, according to examples of the present teachings.

FIG. 4 is a diagram illustrating an exemplary flow of a method to detect intrusion events.

FIG. 5 is a diagram illustrating an exemplary flow of a method to detect a fire in a house by relying on two of the plurality of sensors of FIG. 3.

FIG. 6 is a diagram illustrating an exemplary flow of a method to detect an intruder in a house.

FIG. 7 is a diagram illustrating an exemplary flow of a method to detect a human face.

FIG. 8 illustrates a diagrammatic representation of a machine in the example form of a computer system within which a set of instructions, for causing the machine to perform any one or more of the methodologies discussed herein, may be executed.

### DETAILED DESCRIPTION

Examples of the present teachings employ a system comprising sensors and motion detection and image recognition software that incorporates contextual data from other devices into the system's motion detection and image recognition algorithm. By doing so, the system can make smarter, more accurate predictions. One example of this sensor-laden system is an intercom that interacts with other local intercom units as well as other devices. Through the use of contextually-aware software, the intercom can make more accurate predictions and better understand when to trigger alerts.

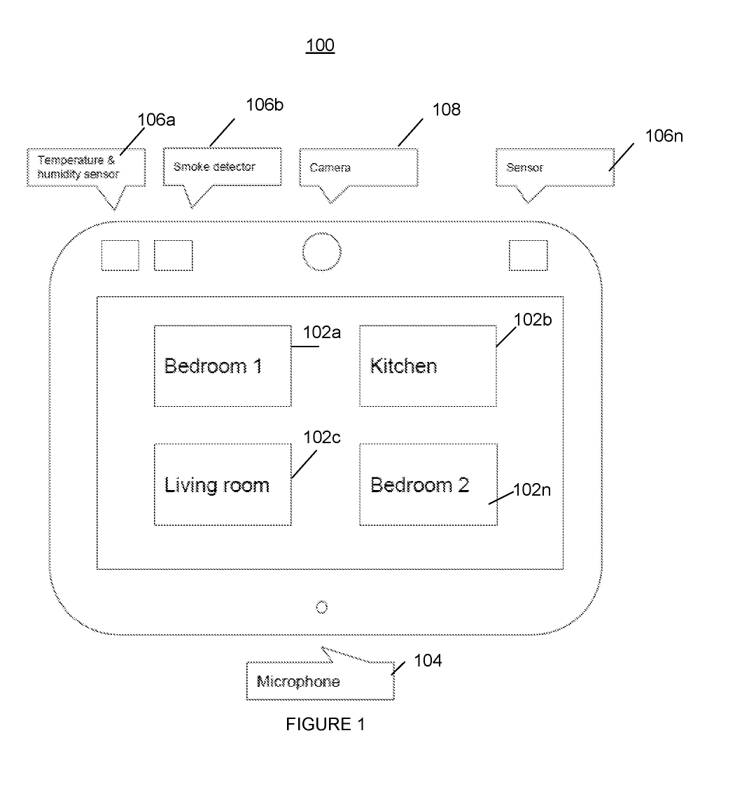

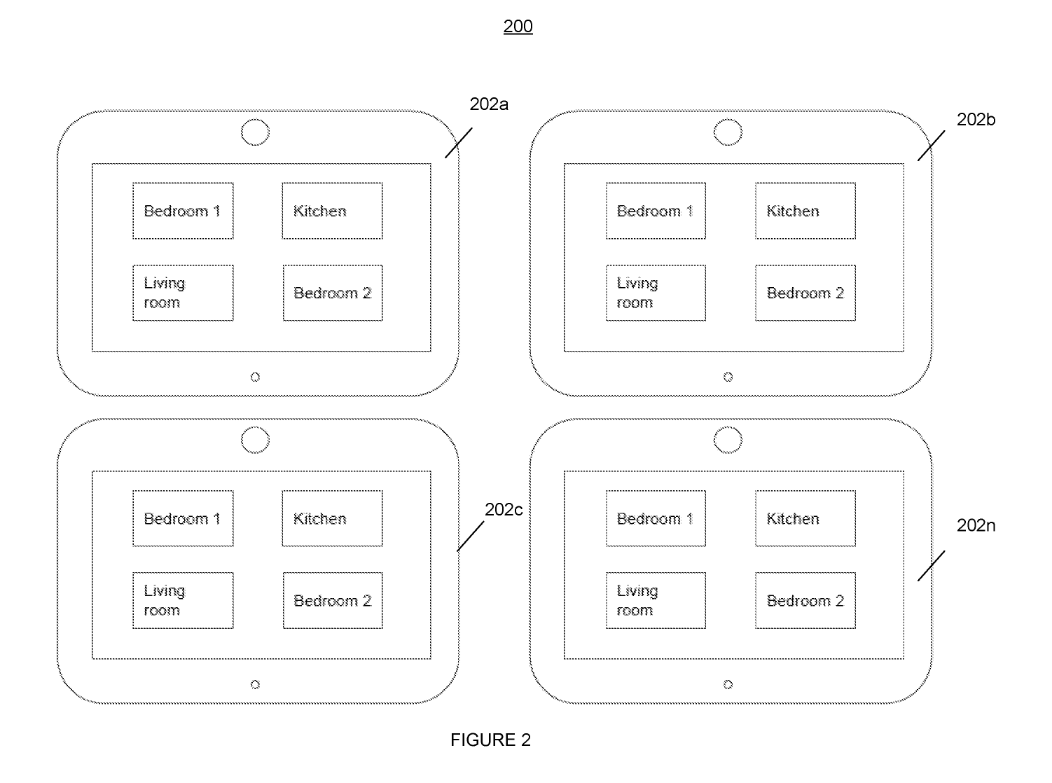

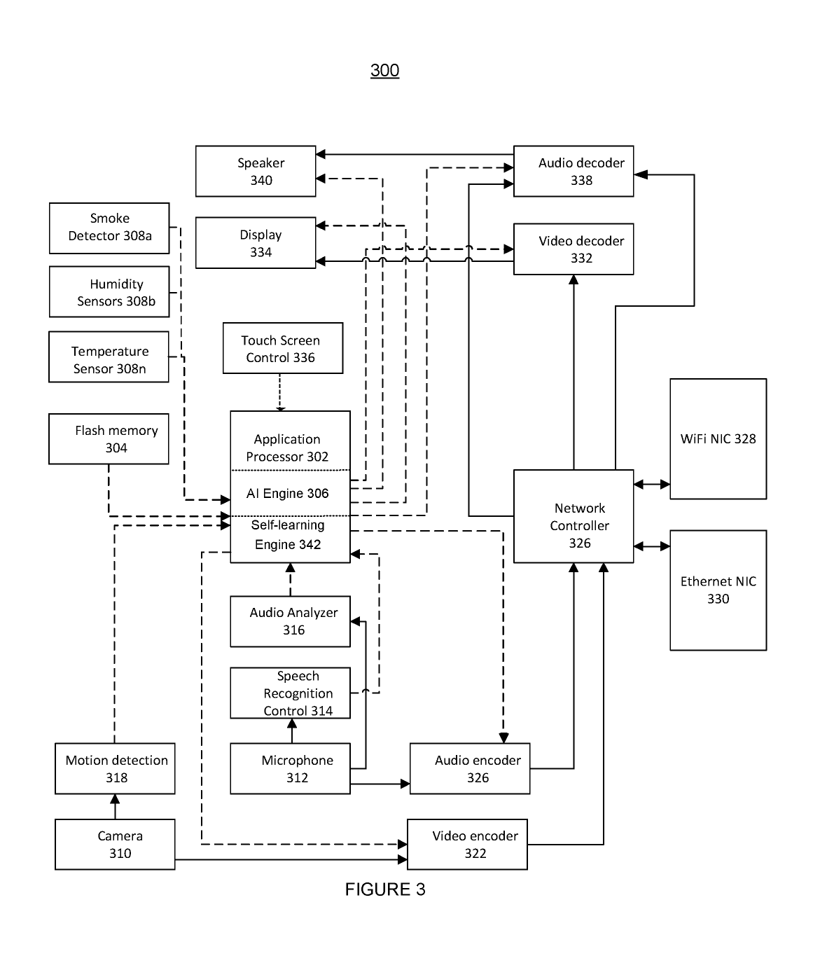

FIG. 1 is a block diagram of plan view of a home 100 having a plurality of rooms 102a-102n therein, in which is distributed a microphone 104, a plurality of sensors 104a-104n and one or more cameras 108 and interconnected by the system 300 described in FIG. 3. FIG. 2 is a block diagram of plan view of multiple homes 200a-200n, each having a plurality of rooms 202a-202n therein, over which the plurality of sensors and cameras are distributed and interconnected by the main unit 300 described in FIG. 3. Some of the contextual data of examples of the present teachings are gleaned from microphones 104, cameras 108, and other sensors 104a-104n either incorporated into the main unit 300 processing the contextual data of FIG. 3 or in other external devices. This contextual data can include images from a single camera (e.g., 106) that are captured for periods of time before and after the event being analyzed. Through using this contextual data, the main unit 300 is able to improve its data-analysis algorithm and provide the end-user with more accurate motion detection and recognition.

In addition, if end-users give feedback on the output of the main unit 300, the main unit 300 can be improved over time by better understanding whether certain events, taken in the context of the overall data collected, should serve as a trigger for a motion detection alert.

FIG. 3 is a block diagram of elements comprising the main unit 300, according to examples of the present teachings. The main unit 300 comprises an application processor 302 (e.g., a processing device) and a memory 304 (e.g., flash memory), the memory 304 configured to store instructions of an artificial intelligence engine 306 for evaluating the overall context of data provided by a plurality of sensors 308a-308n, a camera 310, and a microphone 312 to detect intrusion events. Examples of the artificial intelligence engine may include, but are not limited to, the Alchemy open source artificial intelligence engine found at “https://alchemy.cs.washington.edu/” or the TensorFlow™ product found at “https://www.tensorflow.org/”.

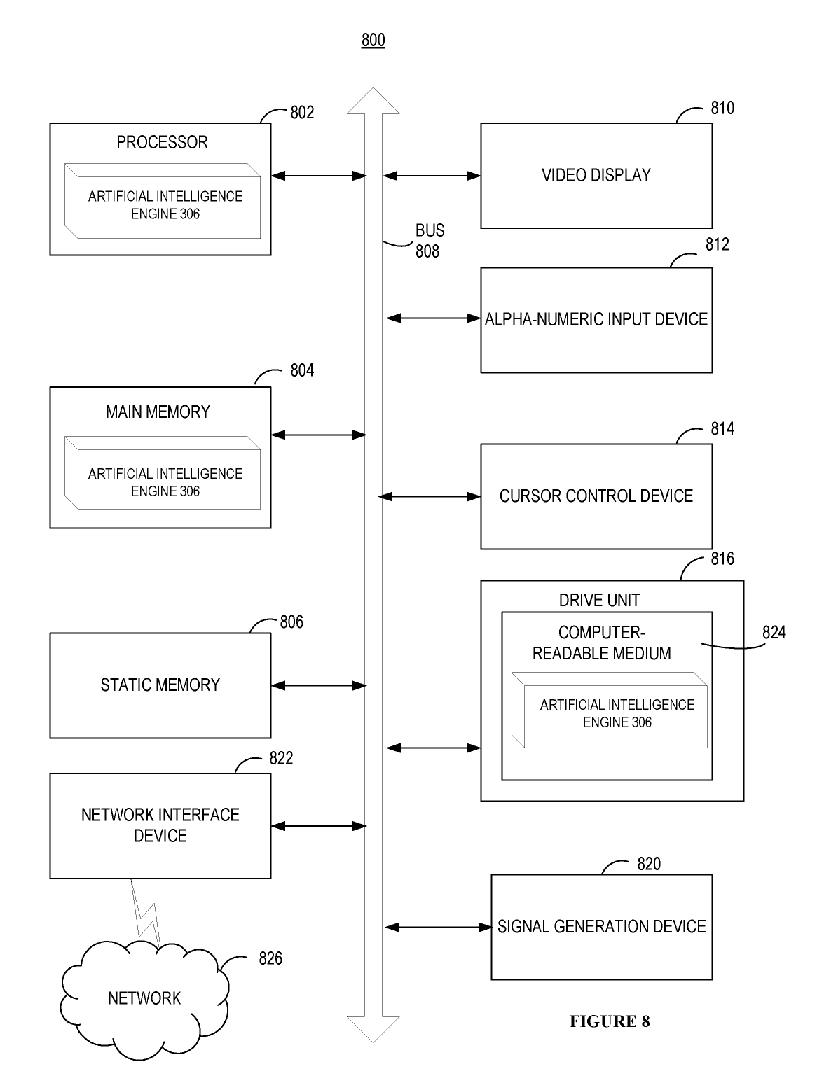

The terms “computer”, “computer platform”, application device, processing device, host, server are intended to include any data processing device, such as a desktop computer, a laptop computer, a tablet computer, a mainframe computer, a server, a handheld device, a digital signal processor (DSP), an embedded processor (an example of which is described in connection with FIG. 8), or any other device able to process data. The computer/computer platform is configured to include one or more microprocessors communicatively connected to one or more non-transitory computer-readable media and one or more networks. The term “communicatively connected” is intended to include any type of connection, whether wired or wireless, in which data may be communicated. The term “communicatively connected” is intended to include, but not limited to, a connection between devices and/or programs within a single computer or between devices and/or separate computers over a network. The term “network” is intended to include, but not limited to, OTA (over-the-air transmission, ATSC, DVB-T), packet-switched networks (TCP/IP, e.g., the Internet), satellite (microwave, MPEG transport stream or IP), direct broadcast satellite, analog cable transmission systems (RF), and digital video transmission systems (ATSC, HD-SDI, HDMI, DVI, VGA), etc.

Audio and video data captured by the microphone 312 and the camera 310, respectively, may be fed for preprocessing by speech recognition control logic 314 and audio analyzer logic 316, as well as motion detector logic 318 before being transmitted to the application processor 302.

In one example, each of a plurality of main units 300 may be incorporated into a wireless system that communicate with each other through Wi-Fi (802.11) technology. Video data may be encoded by a video encoder 322 and audio data encoded by an audio encoder 324 to be further transmitted/received by a network controller 326 communicatively connected wirelessly over a WiFi network interface controller (NIC) 328 or a wired Ethernet Network Interface Controller (NIC) 330 to/from a network of main units and/or a central controller over a wired and/or a wireless network (not shown). The main unit 300 may be further provided with output-enabling devices including, but not limited to, a video decoder 332 coupled to a display 334 that may have a touch screen 336, and an audio decoder 338 coupled to a speaker 340.

Communication within the system may comprise one or more of the following methods: a peer-to-peer setup such as Wi-Fi Direct, using a router to coordinate local area network traffic, using a router and an Internet connection to communicate over a wide area network, using a mesh network, or using wired Ethernet. A connection may be initialized and controlled using, for example, the interactive connectivity establishment (ICE) protocol, which may direct the communication over a session traversal utilities for network address translation (STUN) server or traversal using relays around network address translation (TURN) server depending on the type of router, firewall, and connection employed. The intercom connection may also be initialized and controlled by using the session initiation protocol (SIP) and transmitted via the real-time transport protocol (RTP).

Each system may be comprised of main units 300 grouped together into a mesh-configured network. There may be no dedicated central command device separate from the individual main units 300. The settings of the system as a whole and of the main units 300 collectively or individually may be set from any one of the main units 300 or from a computing device that is not part of the system, such as a user's personal computer or mobile phone.

In an example, the artificial intelligence engine 306 may be configured to receive a plurality of values from a corresponding plurality of heterogeneous sensors 308a-308n and audio/visual data from a microphone 312/camera 310, respectively, corresponding to the detection of motion of an object located in the audio/visual data. Contextual awareness may be aided by incorporating multiple data streams into the artificial intelligence instructions embodying the artificial intelligence engine 306. These data streams can include the output of the microphone 312, the camera 310, and the other sensors 308a-308n which may include, but are not limited to, door and window sensors, smoke detectors, and other environmental particle detectors. In some examples, the sensors 308a-308n are each standalone devices, and in other examples the sensors 308a-308n are incorporated into a single device such as an intercom unit. When received from other devices, these data streams are transmitted over Wi-Fi, Bluetooth, or another wireless protocol to a central unit (not shown) that receives and processes multiple data streams.

The artificial intelligence engine 306 may be configured to evaluating context of the plurality of values from the corresponding plurality of heterogeneous sensors 308a-308n and the audio/visual data from the microphone 312/camera 310, respectively, in view of one or more past values from the plurality of sensors 308a-308n and one or more past frames of audio/visual data from the microphone 312/camera 310, respectively. Responsive to the evaluated context indicating that the motion of the object is suspicious with a probability equal to or above a level, the artificial intelligence engine 306 may be configured to trigger an alert indicating that a suspicious event has occurred. The plurality of values and/or the plurality of past values may be captured over a period of time. The period of time may correspond to time before, during, and after the occurrence of the suspicious event.

The artificial intelligence engine 306 may feed the plurality of values and the audio/visual data into a self-learning engine 342 associated with the artificial intelligence engine 306 to improve on a conclusion made for a future suspicious event. The self-learning engine 342 may be configured to correlate the plurality of values, the audio/visual data, and the indicated suspicious event in view of other sets of the plurality of values and the audio/visual data to determine whether certain events, taken in a context of overall data collected, serves as a trigger for a motion detection alert.

The data streams being analyzed by the artificial intelligence engine 306 may include the identities of various devices detected by wireless sensors. For example, a Wi-Fi or Bluetooth antenna tracks which devices are typically found in certain rooms. This capability permits passive geolocation features to be incorporated into the artificial intelligence engine 306.

In addition, the artificial intelligence engine 306 has the ability to monitor these other devices over a long period of time in order to create one or more baseline scenarios against which potentially suspicious events may be checked.

For example, by recording audio and video of a cat wandering about the home 100, the artificial intelligence engine 306 is able to establish a baseline that a certain pattern of motion in specific rooms 102a-102n, coupled with a certain pattern of audio in specific rooms 102a-102n, is deemed non-suspicious. When the main unit 300 detects motion and/or audio in one of the rooms 102a-102n, the artificial intelligence engine 306 may match that motion and/or audio against the baseline it has established to determine if the motion and/or audio are suspicious and whether or not an alert needs to be triggered.

For more accurate analysis, the artificial intelligence engine 306 also has the ability to analyze simultaneous and recent audio, video, or sensory input in additional rooms 102a-102n throughout the house 100 to determine if the motion detected in one room (e.g., 102a) is consistent with typical non-suspicious behavior.

Facial recognition may also be employed, both to determine the difference between humans and other motion, as well as to learn which humans belong in the home 100 and which humans are foreign to that home 100.

By utilizing multiple detection devices 308a-308n, 310, 312, etc., together with pattern and facial recognition, the artificial intelligence engine 306 can better understand the context of the data it is receiving. For example, the artificial intelligence engine 306 can learn over time that humans typically enter the house through the front door and are not home between the hours of 9 am and 5 pm. If devices in a kitchen detect motion at 10 am one day but the motion alone cannot be accurately identified as either human, animal, or background (e.g., leaves falling outside the window), the artificial intelligence engine 306 may check the front door sensor to see if it had been recently opened; check the microphone to see if there is noise that resembles footsteps; check other cameras to determine if the pet can be located in a different room; check to see if the Wi-Fi or Bluetooth antennas can detect a new mobile device entering a room, and if so, try to determine to whom the device belongs. If the artificial intelligence engine 306 determines that the motion is indeed a human and that human did not enter through the front door, that is deemed suspicious and an alert is triggered. Alternatively, the artificial intelligence engine 306 may, by incorporating contextual awareness, determine that despite the unusual time for a human to be inside the house 100, the face and voice match a frequent occupant of the home and the person entered in a typical fashion (i.e., through the front door). These are determinations that can only be made accurately by incorporating data from multiple devices, over time.

The combination of multiple cameras 310 throughout the home 100 together with an understanding of context also helps the artificial intelligence method of the main unit 300 determine when individuals are in areas in which they do not belong. For example, if a nanny typically spends 100% of her time in a certain set of rooms 102a-102n, the artificial intelligence method of the main unit 300 can identify an anomaly if the nanny is detected in a room (e.g., 102a) that does not belong to her usual set. The main unit 300 may also be user-programmed to send an alert when certain users (identified via facial recognition, voice analysis, cell phone signals, and other information) enter a certain area of the house 100. Log files recording which individuals are present in which rooms 102a-102n at which times can also be kept and displayed.

To assist in the contextual analysis, the artificial intelligence engine 306 constantly analyzes audio packets received from the microphone 312 through the audio encoder 326 in order to identify specific sounds, such as the sound of a smoke detector or a carbon monoxide detector. The device then automatically matches the detected sounds against a database of known sounds, but the user also has the option of inputting customized sounds to help the software better identify them.

The artificial intelligence engine 306 is also able to improve accuracy by analyzing the entirety of a video clip instead of looking at individual still images. By looking at the entirety of a clip, the artificial intelligence engine 306 is able to add context to its analysis. When artificial intelligence engine 306 detects motion in a room, artificial intelligence engine 306 may detect if the motion resembles the movements of a human, animal, or a vehicle outside the window. Using the entirety of the video clip affords the artificial intelligence engine 306 more data to analyze, rather than the device needing to make its determination based on a single still image selected from the video.

When an alert is triggered, the user or an authorized third party is able to categorize the alert as accurate or inaccurate. If the alert is inaccurate, the user or authorized third party can tag the image or audio/video clip with text to help the artificial intelligence engine 306 better understand what it had seen and thereby improve its detection algorithms. Images or behavior similar to the images or behavior that triggered the initial alert would no longer be deemed suspicious and an alert would not be triggered. Over time, the user and/or authorized third party is able to train the artificial intelligence engine 306 into making better predictions.

When a user or authorized third party categorizes an alert as either accurate or inaccurate, the metadata of the alert—time of day; coordinates of motion in the frame; audio levels, and other metadata (but not the actual image or audio)—may be transmitted to a central server (not shown) for inclusion in a master database (not shown) of alerts in order to help other unrelated devices improve their accuracy over time.

A user of the main unit 300 is able to change the sensitivity of alert triggers, as well as determine which sensors are used to help the software determine the context of the alert. For example, a homeowner with a cat may turn down the sensitivity to prevent false alerts based on the motion of the cat, as well as determine that the cameras near windows send too much false information and should not be queried when the system is detecting contextually relevant information.

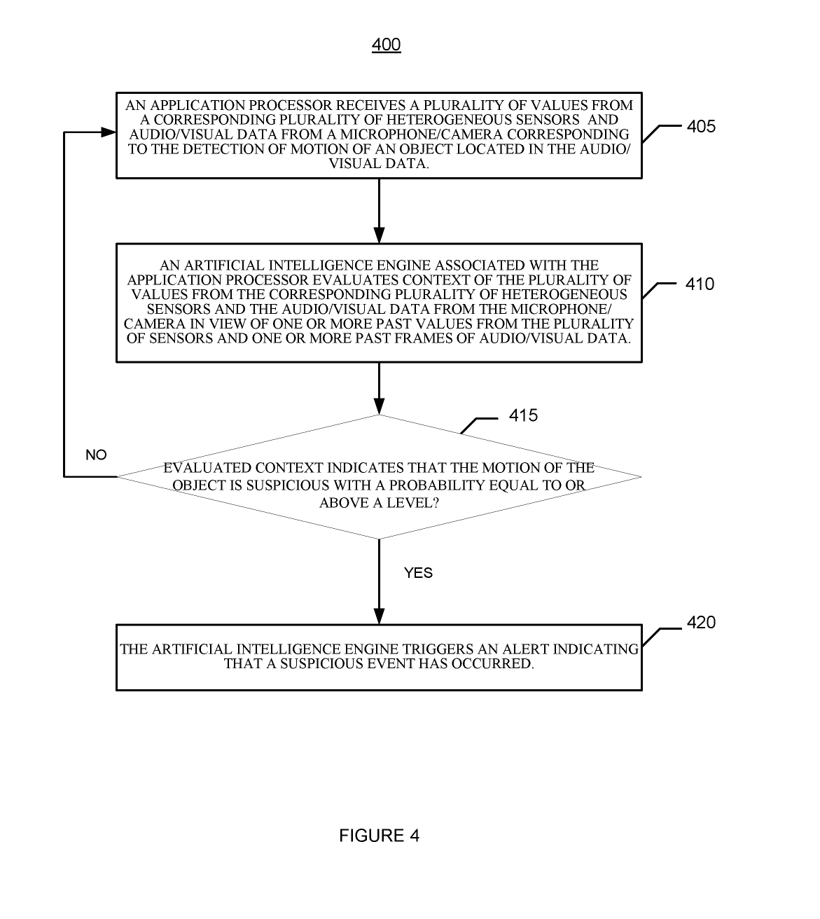

FIG. 4 is a diagram illustrating an exemplary flow of a method 400 to detect intrusion events. The method 400 may be performed by a main unit 300 of FIG. 3 and may comprise hardware (e.g., circuitry, dedicated logic, programmable logic, microcode, etc.), software (e.g., instructions run on a processing device), or a combination thereof. In one example, the method 400 may be performed by components of the main unit 300 of FIG. 3.

As shown in FIG. 4, at block 405, an application processor 302 may receive a plurality of values from a corresponding plurality of heterogeneous sensors 308a-308n and audio/visual data from a microphone 312/camera 310 corresponding to the detection of motion of an object located in the audio/visual data. At block 410, an artificial intelligence engine 306 executed by the application processor 302 may evaluate context of the plurality of values from the corresponding plurality of heterogeneous sensors 308a-308n and the audio/visual data from the microphone 312/camera 310 in view of one or more past values from the plurality of sensors 308a-308n and one or more past frames of audio/visual data. At block 415, if the evaluated context indicates that the motion of the object is suspicious with a probability equal to or above a level, then at block 420, the artificial intelligence engine 306 triggers an alert indicating that a suspicious event has occurred. If, at block 415, the evaluated context indicates that the motion of the object is suspicious with a probability below the level, the processing returns to block 405.

The application processor 302 may capture the plurality of values and the audio/visual data over a period of time. The period of time may correspond to time before, during, and after the occurrence of the suspicious event.

The application processor 302 may create one or more baseline scenarios against which potentially suspicious events are compared. The application processor 302 may transmit the plurality of values and the audio/visual data into a self-learning engine 342 (method) associated with the artificial intelligence engine 306 (method) to improve on a conclusion made for a future suspicious event. The self-learning engine 342 may correlate the plurality of values, the audio/visual data, and the indicated suspicious event in view of other sets of the plurality of values and the audio/visual data to determine whether certain events, taken in a context of overall data collected, serves as a trigger for a motion detection alert.

The plurality of heterogeneous sensors 308a-308n may comprise one or more of a camera, a microphone, a door sensor, a window sensor, a smoke detector, or another type of environmental particle detector. The data from the plurality of heterogeneous sensors 308a-308n and the audio/visual data may be received by the application processor 302 over a corresponding plurality of wireless communication channels. The plurality of heterogeneous sensors 308a-308n and a plurality of devices that capture the audio/visual data may be distributed over a plurality of rooms 102a-102n in a building 100. Accordingly, the artificial intelligence engine 306 may analyze data generated by plurality of devices that capture the audio/visual data simultaneously and analyzing prior captured data to determine if motion detected in one room is consistent with non-suspicious behavior.

The artificial intelligence engine 306 may employ a facial recognition method to determine the difference between a human and other motion, as well as to learn which humans belong in a building 100 and which humans are foreign to that building 100.

In an example, the application processor 302 may compare a sound corresponding to the received audio data against a database of known sounds.

In an example, the application processor 302 may receive an indication from a user that the alert is accurate or inaccurate. Accordingly, the application processor 302 may receive from an end user or system operator a tag to associate with the audio/visual data as an aid for the artificial intelligence engine 306 to use for detecting future motion detection events.

When an alert is categorized as accurate or inaccurate, the application processor 302 may transmit to a central server (not shown), metadata associated with the received data for inclusion in a master database (not shown) of alerts in order to help other unrelated devices improve their accuracy over time.

Prior to receiving the plurality of values from the corresponding plurality of heterogeneous sensors 308a-308n, the application processor 302 may receive a plurality of preset values corresponding to the plurality of heterogeneous sensors 308a-308n and train the artificial intelligence engine with the plurality of preset values to determine events and alerts.

The application processor 302 may store in the memory 304 a log of each detected event to aid in the artificial intelligence engine 306 to render future detections of events. The artificial intelligence engine may further employing a prediction method to measure a response time of a user to one or more detected events and classify a severity of each of the one or more events based on the response time.

In an example, the application processor 302 triggering an alert may further comprises indicating a probable cause of the event. Triggering an alert may further comprises indicating one or more probabilities of the type of object that caused the motion.

The application processor 302 of the main unit 300 may broadcast the received plurality of values to one or more other processing devices of main units 300 in a network of processing devices to aid in detection of events. One or more of the received plurality of values may originate from one or more other main units 300 in a network of main units 300 to aid in detection of events.

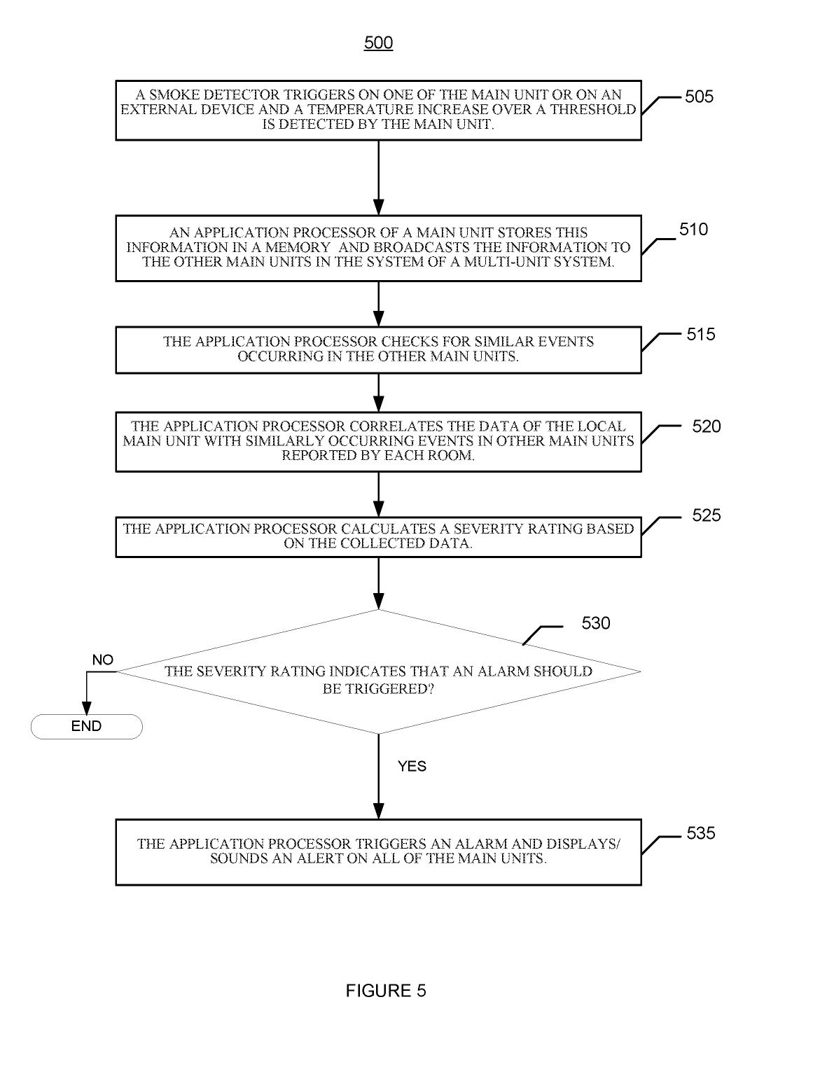

FIG. 5 is a diagram illustrating an exemplary flow of a method 500 to detect a fire in a house by relying on two of the plurality of sensors 308a-308n of FIG. 3. The sensors may be, for example, the smoke detector 308a which can be an external unit that is installed as a stand-alone device, or a sensor within the main unit 300, and the temperature sensor 308n installed in the main unit 300. The method 500 may be performed by a main unit 300 of FIG. 3 and may comprise hardware (e.g., circuitry, dedicated logic, programmable logic, microcode, etc.), software (e.g., instructions run on a processing device), or a combination thereof. In one example, the method 500 may be performed by components of the main unit 300 of FIG. 3.

As shown in FIG. 5, at block 505, the smoke detector 308a triggers on one of the main units 300 or on an external device and a temperature increase over a threshold is detected by the main nit 300. At block 510, the application processor 302 of the main unit 300 stores this information in the memory 304 and broadcasts this information to the other main units 300 in the system of a multi-unit system. At block 515, the application processor 302 checks for similar events occurring in the other main units 300. At block 520, the application processor 302 correlates the data of the local main unit 300 with similarly occurring events in other main units reported by each room 102a-102n and, at block 525, the application processor 302 calculates a severity rating based on the data. If, at block 530, the severity rating indicates that an alarm should be triggered, then at block 535, the application processor 302 triggers an alarm and displays/sounds an alert on all of the main units 300. If, at block 530, the severity indicates that an alarm should not be triggered, then the method terminates.

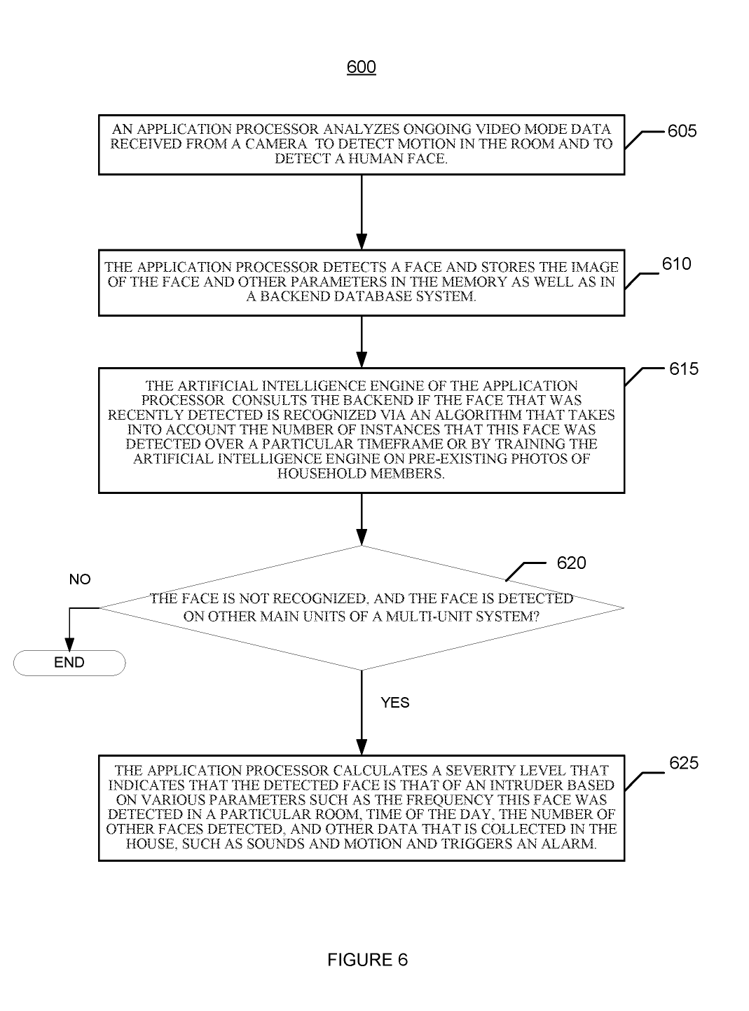

FIG. 6 is a diagram illustrating an exemplary flow of a method 600 to detect an intruder in a house. Detecting an intruder may be based on the ability of the main unit 300 as a whole detecting human motion in a room 102a. The main unit 300 may place the camera 310 in continuous video mode, detect a face, compare the face to a database of “recognized” faces, and trigger an alarm if it is likely (probable) that the detected face is of an intruder. The method 600 may be performed by a main unit 300 of FIG. 3 and may comprise hardware (e.g., circuitry, dedicated logic, programmable logic, microcode, etc.), software (e.g., instructions run on a processing device), or a combination thereof. In one example, the method 600 may be performed by components of the main unit 300 of FIG. 3.

As shown in FIG. 6, at block 605, the application processor 302 analyzes ongoing video mode data received from the camera 310 to detect motion in the room and to detect a human face. At block 610, the application processor 302 detects a face and stores the image of the face and other parameters e.g., timestamp and location) in the memory 304 as well as in a backend database system (not shown). At block 615, the artificial intelligence engine 306 of the application processor 302 consults the backend if the face that was recently detected is recognized via an algorithm that takes into account the number of instances that this face was detected over a particular timeframe or by training the artificial intelligence engine 306 on pre-existing photos of household members. At block 620, if the face is not recognized, and the face is detected on other main units 300 of a multi-unit system, then at block 625, the application processor 302 calculates a severity level that indicates that the detected face is that of an intruder based on various parameters such as the frequency this face was detected in a particular room, time of the day, the number of other faces detected, and other data that is collected in the house, such as sounds and motion and triggers an alarm. If, at block 620, the severity indicates that an alarm should not be triggered, then the method terminates.

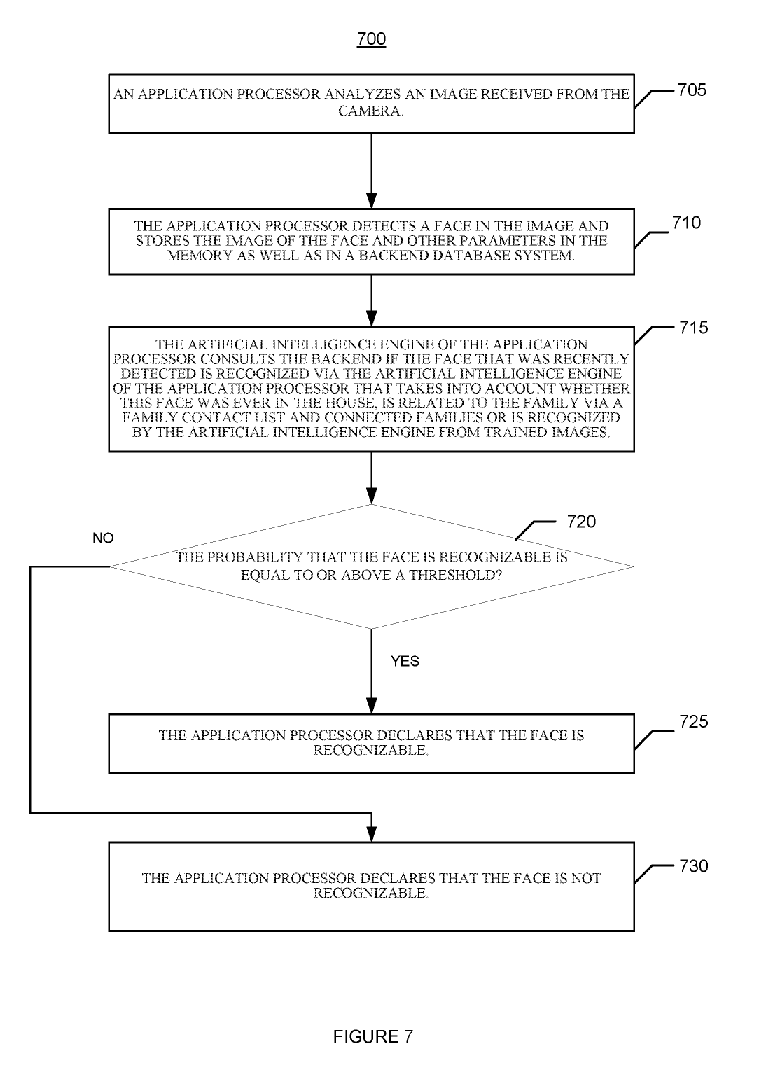

FIG. 7 is a diagram illustrating an exemplary flow of a method 700 to detect a human face. The system that recognizes human faces from single image out of a large database containing multiple images per person. Faces are represented by labeled graphs, based on a Gabor wavelet transform for example but this can be any face detection algorithm. Image graphs of new faces are extracted by a search process and can be compared by a simple similarity function.

The method 700 may be performed by a main unit 300 of FIG. 3 and may comprise hardware (e.g., circuitry, dedicated logic, programmable logic, microcode, etc.), software (e.g., instructions run on a processing device), or a combination thereof. In one example, the method 700 may be performed by components of the main unit 300 of FIG. 3.

As shown in FIG. 7, at block 705, the application processor 302 analyzes an image received from the camera 310. At block 710, the application processor 302 detects a face in the image and stores the image of the face and other parameters (e.g., timestamp and location) in the memory 304 as well as in a backend database system (not shown). At block 715, the artificial intelligence engine 306 of the application processor 302 consults the backend if the face that was recently detected is recognized via the artificial intelligence engine 306 of the application processor 302 that takes into account whether this face was ever in the house, is related to the family via a family contact list and connected families or is recognized by the artificial intelligence engine 306 from trained images. At block 720, if the artificial intelligence engine 306 determines that the probability that the face is recognizable is equal to or above a threshold, then at block 725, the application processor 302 declares that the face is recognizable. At block 720, if the artificial intelligence engine 306 determines that the probability that the face is recognizable below the threshold, then at block 730, the application processor 302 declares that the face is not recognizable.

FIG. 8 illustrates a diagrammatic representation of a machine in the example form of a computer system 800 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 800 includes a processing device (processor) 802, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a data storage device 816, which communicate with each other via a bus 808.

Processing device 802 represents one or more general-purpose processing devices such as a processor, a microprocessor, a central processing unit, or the like. More particularly, the processing device 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also be one or more special-purpose processing devices such as an application specific integrated circuit (ASIC), a field programmable gate array (FPGA), a digital signal processor (DSP), network processor, or the like. The processing device 802 is configured to execute instructions for performing the operations and steps discussed herein, illustrated in FIG. 8 by depicting instructions for the artificial intelligence engine 306 within the processing device 802.

The computer system 800 may further include a network interface device 822. The computer system 800 also may include a video display unit 810 (e.g., a liquid crystal display (LCD) or a cathode ray tube (CRT)), an alphanumeric input device 812 (e.g., a keyboard), a cursor control device 814 (e.g., a mouse), and a signal generation device 820 (e.g., a speaker).

The data storage device 816 may include a computer-readable storage medium 824 on which is stored one or more sets of instructions (e.g., instructions for the VTN server 120) embodying any one or more of the methodologies or functions described herein. The instructions for the artificial intelligence engine 306 may also reside, completely or at least partially, within the main memory 804 and/or within the processing device 802 during execution thereof by the computer system 800, the main memory 804 and the processing device 802 also constituting computer-readable storage media. The instructions for the artificial intelligence engine 306 may further be transmitted or received over a network 810 via the network interface device 822.

While the computer-readable storage medium 824 is shown in an embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “transmitting”, “receiving”, “translating”, “processing”, “determining”, and “executing”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
receiving, by an application processor, a plurality of values from a corresponding plurality of heterogeneous sensors and audio/visual data corresponding to the detection of motion of an object located in the audio/visual data;
evaluating context, using an artificial intelligence engine executed by the application processor, of the plurality of values from the corresponding plurality of heterogeneous sensors and the audio/visual data in view of one or more past values from the plurality of sensors and one or more past frames of audio/visual data; and
triggering, by the artificial intelligence engine, in response to the evaluated context indicating that the motion of the object is suspicious with a probability equal to or above a level, an alert indicating that a suspicious event has occurred.

2. The method of claim 1, further comprising capturing the plurality of values and the audio/visual data over a period of time.

3. The method of claim 2, wherein the period of time corresponding to time before, during, and after the occurrence of the suspicious event.

4. The method of claim 2, wherein capturing the plurality of values and the audio/visual data over a period of time comprises creating one or more baseline scenarios against which potentially suspicious events are compared.

5. The method of claim 1, further comprising feeding the plurality of values and the audio/visual data into a self-learning method associated with the artificial intelligence method to improve on a conclusion made for a future suspicious event.

6. The method of claim 5, wherein the self-learning method correlates the plurality of values, the audio/visual data, and the indicated suspicious event in view of other sets of the plurality of values and the audio/visual data to determine whether certain events, taken in a context of overall data collected, serves as a trigger for a motion detection alert.

7. The method of claim 1, wherein the plurality of heterogeneous sensors comprise one or more of a camera, a microphone, a door sensor, a window sensor, a smoke detector, or another type of environmental particle detector.

8. The method of claim 1, wherein the data from the plurality of heterogeneous sensors and the audio/visual data are received by the processing device over a corresponding plurality of wireless communication channels.

9. The method of claim 1, wherein the plurality of sensors and a plurality of devices that capture the audio/visual data are distributed over a plurality of rooms in a building, and further comprising analyzing, by the artificial intelligence method, data generated by plurality of devices that capture the audio/visual data simultaneously and analyzing prior captured data to determine if motion detected in one room is consistent with non-suspicious behavior.

10. The method of claim 1, further comprising employing, by the artificial intelligence method, a facial recognition method to determine the difference between a human and other motion, as well as to learn which humans belong in a building and which humans are foreign to that building.

11. The method of claim 1, further comprising comparing a sound corresponding to the received audio data against a database of known sounds.

12. The method of claim 1, further comprising receiving, by the application processor, an indication from a user that the alert is accurate or inaccurate.

13. The method of claim 12, wherein receiving the indication that the alert is accurate or inaccurate comprises receiving a tag to associate with the audio/visual data as an aid for the artificial intelligence algorithm to use for detecting future motion detection events.

14. The method of claim 1, further comprising when an alert is categorized as accurate or inaccurate, transmitting, by the application processor to a central server, metadata associated with the received data for inclusion in a master database of alerts in order to help other unrelated devices improve their accuracy over time.

15. The method of claim 1, further comprising, prior to receiving the plurality of values from the corresponding plurality of heterogeneous sensors,
receiving, by the application processor, a plurality of preset values corresponding to the plurality of heterogeneous sensors and
training the artificial intelligence method with the plurality of preset values to determine events and alerts.

16. The method of claim 1, further comprising, storing, by the application processor in a memory, a log of each detected event to aid in the artificial intelligence method to render future detections of events.

17. The method of claim 1, further comprising:
employing a prediction engine to measure a response time of a user to one or more detected events; and
classifying a severity of each of the one or more events based on the response time.

18. The method of claim 1, wherein triggering an alert further comprises indicating a probable cause of the event.

19. The method of claim 1, wherein triggering an alert further comprises indicating one or more probabilities of the type of object that caused the motion.

20. The method of claim 1, further comprising, broadcasting, by the application processor, the received plurality of values to one or more other processing devices in a network of processing devices to aid in detection of events.

21. The method of claim 1, wherein one or more of the received plurality of values originate from one or more other processing devices in a network of application processors to aid in detection of events.

22. A system comprising:
a memory;
an application processor, operatively coupled to the memory to:
receive a plurality of values from a corresponding plurality of heterogeneous sensors and audio/visual data corresponding to the detection of motion of an object located in the audio/visual data;
evaluate context, using an artificial intelligence engine, of the plurality of values from the corresponding plurality of heterogeneous sensors and the audio/visual data in view of one or more past values from the plurality of sensors and one or more past frames of audio/visual data; and
trigger, by the artificial intelligence engine, in response to the evaluated context indicating that the motion of the object is suspicious with a probability equal to or above a level, an alert indicating that a suspicious event has occurred.

23. A non-transitory computer-readable medium storing instructions that when executed by an application processor, cause the application processor to:
receive a plurality of values from a corresponding plurality of heterogeneous sensors and audio/visual data corresponding to the detection of motion of an object located in the audio/visual data;
evaluate context, using an artificial intelligence engine, of the plurality of values from the corresponding plurality of heterogeneous sensors and the audio/visual data in view of one or more past values from the plurality of sensors and one or more past frames of audio/visual data; and
trigger, by the artificial intelligence engine, in response to the evaluated context indicating that the motion of the object is suspicious with a probability equal to or above a level, an alert indicating that a suspicious event has occurred.
